(19) United States
(12) Patent Application Publication
(10) Pub. No.: US 2015/0022551 A1
(43) Pub. Date: Jan. 22, 2015

(54) DISPLAY DEVICE AND CONTROL METHOD THEREOF

(71) Applicant: LG ELECTRONICS INC., Seoul (KR)

(72) Inventors: Jihwan KIM, Seoul (KR); Hyorim PARK, Seoul (KR); Jongho KIM, Seoul (KR); Sinae CHUN, Seoul (KR); Eunhyung CHO, Seoul (KR)

(73) Assignee: LG ELECTRONICS INC., Seoul (KR)

(21) Appl. No.: 14/074,206

(22) Filed: Nov. 7, 2013

(30) Foreign Application Priority Data
Jul. 19, 2013 (KR) 10-2013-0085453

(51) Int. Cl. G06T 19/00

(52) U.S. Cl. CPC G06T 19/006
USPC 345/633

(57) ABSTRACT

Discussed are a display device that copies a virtual image mapped to a marker to another marker and a control method thereof. The display device includes a sensor unit configured to sense an input to the display device, a camera unit configured to capture a surrounding image of the display device, a display unit configured to display a virtual image, and a processor configured to control the sensor unit, the camera unit, and the display unit. The processor is further configured to acquire information regarding a first virtual image mapped to a first marker and display the first virtual image using the acquired information regarding the first virtual image, when the first marker is recognized from the captured surrounding image, and maintain display of the first virtual image, when a copy trigger signal for the first virtual image is received and a second marker is overlaid on the first marker.

This application claims the benefit of Korean Patent Application No. 10-2013-0085453, filed on Jul. 19, 2013, which is hereby incorporated by reference as if fully set forth herein.

### BACKGROUND OF THE INVENTION

1. Field of the Invention

The disclosure relates to a device equipped with a display unit and, more particularly, to a display device that copies a virtual image mapped to a marker to another marker and a control method thereof.

2. Discussion of the Related Art

With increasing necessity of augmented reality (AR) in recent years, various technologies using an AR marker have been developed. As a result, a user may see a virtual image mapped to the AR marker through a display unit included in a device, thereby experiencing various kinds of augmented reality. However, a specific AR marker is needed for a user to see a specific virtual image. For this reason, user accessibility to and usability of a virtual image is not sufficiently guaranteed. In addition, a virtual image, if mapped to an AR marker once, may not be easily edited in a manner in which a user wishes to.

### SUMMARY OF THE INVENTION

Accordingly, embodiments are directed to a display device and a control method thereof that substantially obviate one or more problems due to limitations and disadvantages of the related art.

One embodiment provides a display device that copies a virtual image and maps the copied virtual image to another marker upon receiving a copy trigger signal and a control method thereof.

Another embodiment provides a display device that maintains display of a virtual image of an original marker although another marker is overlaid on the original marker upon receiving a copy trigger signal and a control method thereof.

Another embodiment provides a display device including a signal generated by a predetermined gesture input and/or a signal generated through recognition of a copy marker as a copy trigger signal and a control method thereof.

A further embodiment provides a display device that provides a mode to edit a virtual image upon receiving an image edit signal and a control method thereof.

Additional advantages, objects, and features of the embodiments will be set forth in part in the description which follows and in part will become apparent to those having ordinary skill in the art upon examination of the following or may be learned from practice of the embodiments. The objectives and other advantages of the embodiments may be realized and attained by the structure particularly pointed out in the written description and claims hereof as well as the appended drawings.

To achieve these objects and other advantages and in accordance with the purpose of the embodiments, as embodied and broadly described herein, a display device includes a sensor unit configured to sense an input to the display device, a camera unit configured to capture a surrounding image of the display device, a display unit configured to display a virtual image, and a processor configured to control the sensor unit, the camera unit, and the display unit, wherein the processor is further configured to acquire information regarding a first virtual image mapped to a first marker and display the first virtual image using the acquired information regarding the first virtual image, when the first marker is recognized from the captured surrounding image, maintain display of the first virtual image, when a copy trigger signal for the first virtual image is received and a second marker is overlaid on the first marker, and map the information regarding the first virtual image to the second marker, when a copy signal for the first virtual image is received.

It is to be understood that both the foregoing general description and the following detailed description of the embodiments are exemplary and explanatory and are intended to provide further explanation of the embodiments as claimed.

### BRIEF DESCRIPTION OF THE DRAWINGS

The accompanying drawings, which are included to provide a further understanding of the disclosure and are incorporated in and constitute a part of this application, illustrate embodiment(s) and together with the description serve to explain the principle of the disclosure. In the drawings:

FIG. 1 is a block diagram of a display device according to one embodiment;

FIGS. 2A-2B are views showing a device that copies a virtual image mapped to a marker to another marker according to a received signal;

FIG. 3 is a view showing one embodiment of a virtual image scrapbook using marker copying;

FIG. 4 is a view showing one embodiment of a device that copies a virtual image using a portion of the body of a user as a second marker;

FIG. 5 is a view showing a device in a case in which an image edit signal is received through the device according to one embodiment;

FIG. 6 is a view showing a device in a case in which an image edit signal for a virtual image is received according to one embodiment;

FIG. 7 is a view showing a device that provides a predetermined notification in a case in which a virtual image pre-mapped to a second marker is present according to one embodiment;

FIG. 8 is a view showing a device that provides thumbnails to respectively select a virtual image to be displayed in a case in which the virtual images are mapped to one marker according to one embodiment; and

FIG. 9 is a flowchart showing a control method of a device that copies a virtual image from a first marker to a second marker.

### DETAILED DESCRIPTION OF THE INVENTION

Although the terms used in the following description are selected, as much as possible, from general terms that are widely used at present while taking into consideration the functions obtained in accordance with the embodiments, these terms may be replaced by other terms based on intentions of those skilled in the art, customs, emergence of new technologies, or the like. In addition, in a particular case, terms that are arbitrarily selected by the applicant may be used. In this case, the meanings of these terms may be described in corresponding parts of the disclosure. Accordingly, it should be noted that the terms used herein should be construed based on practical meanings thereof and the whole content of this specification, rather than being simply construed based on names of the terms.

Moreover, although the embodiments will be described herein in detail with reference to the accompanying drawings and content described in the accompanying drawings, it should be understood that the disclosure is not limited to or restricted by the embodiments.

The disclosure relates to a device equipped with a display unit, which will hereinafter be referred to as a display device. The display device refers to various electronic devices having mobility including, for example, a mobile phone, a personal digital assistant (PDA), a laptop computer, a tablet PC, an MP3 player, a CD player, a DVD player, a head mounted display (HMD), a smart watch, and a watch phone. Hereinafter, the display device may simply be referred to as a device.

In particular, the disclosure relates to a display device that displays a virtual image mapped to an augmented reality (AR) marker. AR is an abbreviation of augmented reality in which the real world, which a user sees, and a virtual world having additional information are combined. The AR marker indicates a specific image to which a virtual image is mapped. The AR marker may function as a medium interconnecting the real world and the virtual world. In the disclosure, the AR marker may simply be referred to as a marker.

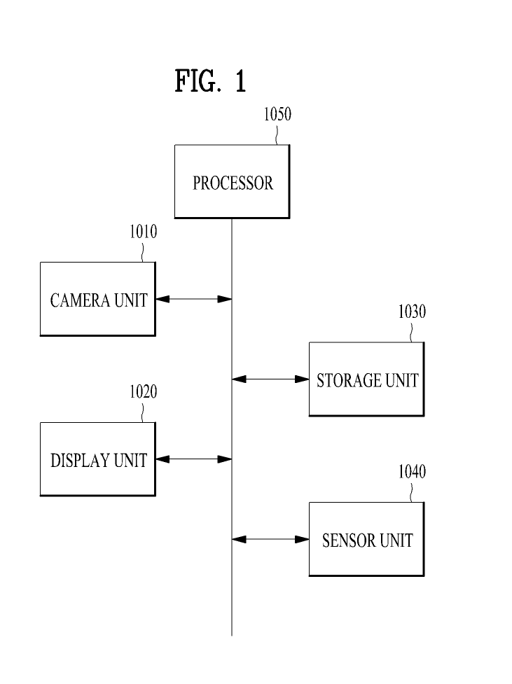

FIG. 1 is a block diagram of a display device according to one embodiment. In the disclosure, the display device may include a camera unit 1010, a display unit 1020, a sensor unit 1040, a storage unit 1030, and a processor 1050.

The camera unit 1010 may capture an image around the device. More specifically, the camera unit 1010 may capture an image within an angle of view and may provide the captured result to the processor 1050. In the disclosure, the image may be various other visible images that may be captured by camera unit.

The display unit 1020 may display a virtual image. Particularly in the disclosure, the display unit 1020 may display a virtual image mapped to an AR marker. The virtual image may include a graphical user interface provided to a user through the display unit 1020. Particularly in a case in which the display device is an HMD, the display unit 1020 may be constituted by an optical see-through display panel. In this case, the display unit 1020 may display a virtual image based on a real world to provide a user with augmented reality. In addition, the display unit 1020 may display different images to a left eye and a right eye of the user to generate a binocular disparity, providing a three-dimensional (3D) virtual image having depth.

The sensor unit 1040 may sense a user input to the device using at least one sensor equipped in the device. More specifically, the sensor unit 1040 may sense a user touch input on the display unit 1020 using at least one sensor equipped in the device. The at least one sensor may include various sensors, such as a touch sensor, a fingerprint sensor, a motion sensor, a proximity sensor, a depth sensor, and a pressure sensor. The sensor unit 1040 is a generic term for the aforementioned various sensors. The aforementioned sensors may be embodied as separate elements included in the device or may be combined to constitute at least one element included in the device.

The sensor unit 1040 may sense various contact or non-contact touch inputs, such as a long-press touch input, a short-press touch input, a drag touch input, a release touch input, a hovering input, and a flicking touch input, of the user. Moreover, the sensor unit 1040 may sense a touch input by various touch input tools, such as a touch pen and a stylus pen, and may transmit the sensed result to the processor 1050.

On the other hand, in a case in which the display device is an HMD, the sensor unit 1040 may be selectively provided in the device.

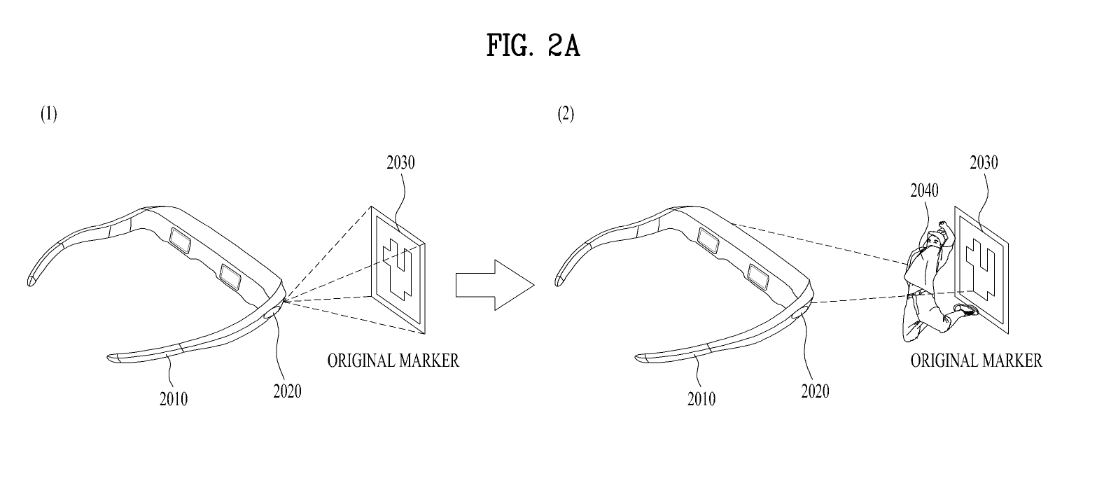

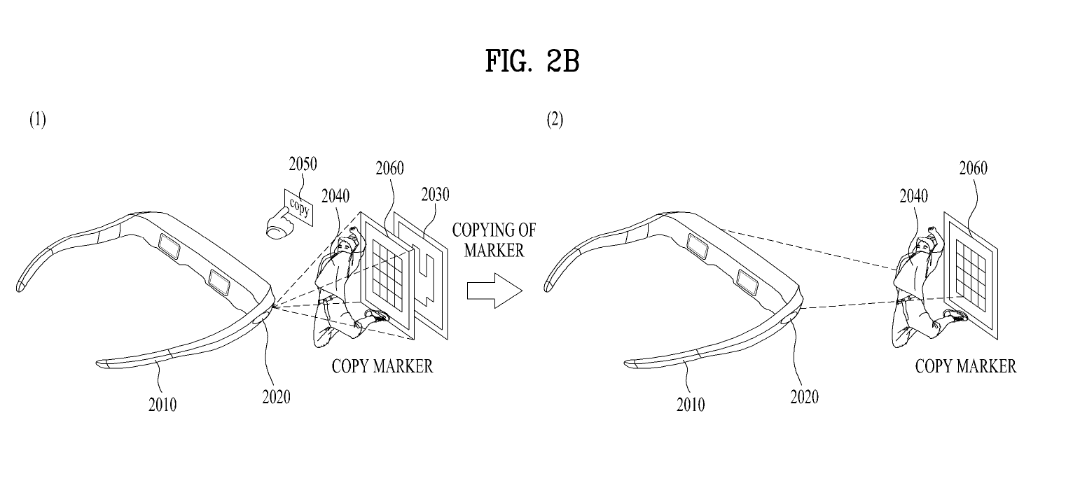

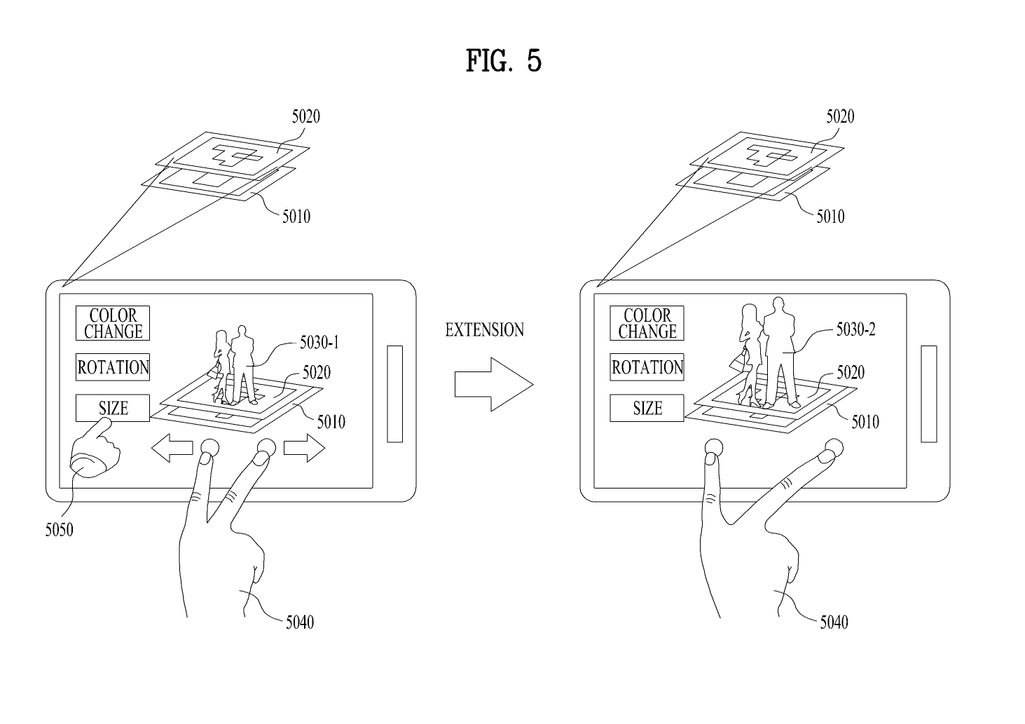

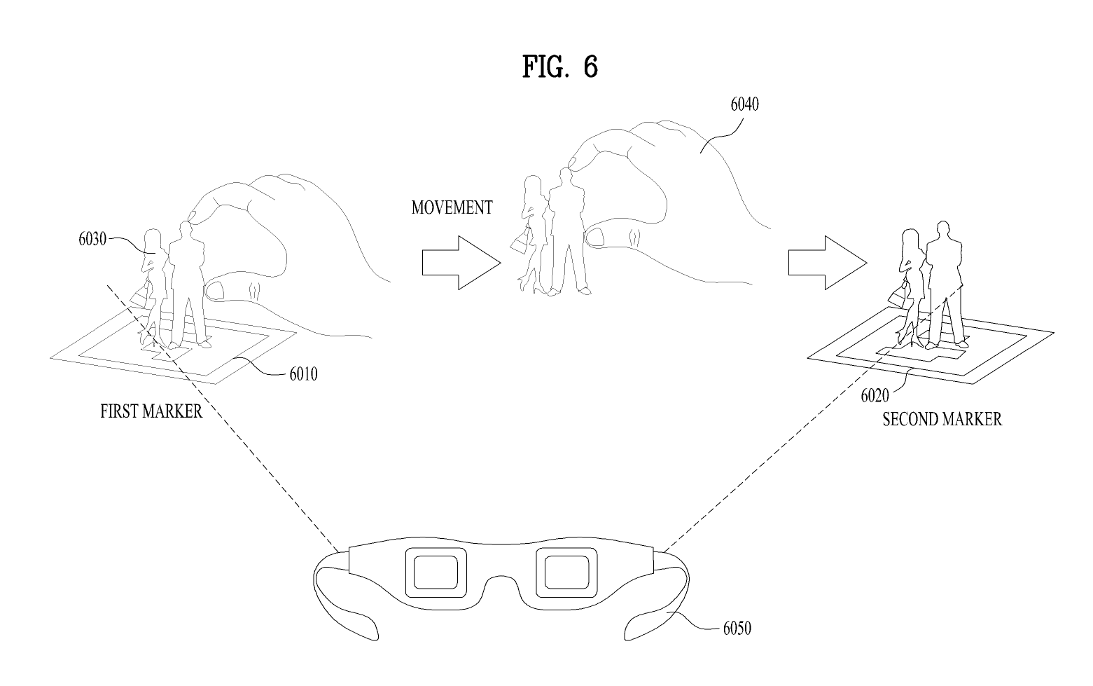

The storage unit 1030 may store information regarding a marker and/or a virtual image. More specifically, the storage unit 1030 may store information regarding a marker such that the processor 1050 may recognize the marker through the camera unit 1010. In addition, the storage unit 1030 may also store information regarding a virtual image mapped to the marker recognized by the processor 1050. Consequently, the processor 1050 may recognize a marker stored in the storage unit 1030 from an acquired surrounding image, may retrieve information regarding a virtual image corresponding to the marker from the storage unit 1030, and may display the retrieved information on the display unit 1020, a detailed description of which will hereinafter be given with reference to FIG. 2 and the following drawings. In addition, the storage unit 1030 may also store information regarding an edited virtual image, a detailed description of which will hereinafter be given with reference to FIGS. 5 and 6.

The processor 1050 may execute various applications by processing data in the device. In addition, the processor 1050 may control execution of content in the device based on input. In addition, the processor 1050 may control the aforementioned respective units of the device and data transmission/reception between the units.

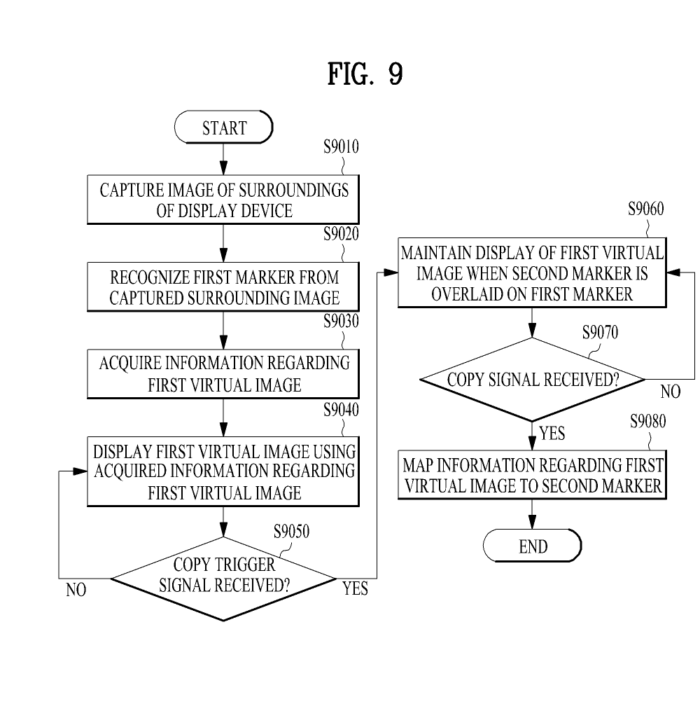

For example, in a case in which the sensor unit 1040 senses a touch input, the processor 1050 may execute a command according to the touch input. Alternatively, in a case in which the camera unit 1010 senses a user gesture input, the processor 1050 may execute a command according to the gesture input. More specifically, an input signal, a copy trigger signal, a copy signal, or an image edit signal may be generated according to the sensed touch input and/or the sensed gesture input. When receiving the respective signals, the processor 1050 may perform operations according to the respective signals, a detailed description of which will hereinafter be given with reference to FIGS. 2 and 9.

In addition, the processor 1050 may recognize a marker through the camera unit 1010 and may display a virtual image mapped to the recognized marker. More specifically, the processor 1050 may acquire information regarding a virtual image corresponding to the recognized marker and may display the virtual image using the acquired information. The processor 1050 may acquire information regarding a virtual image from an external server or may acquire information regarding a virtual image prestored in the storage unit 1030.

In addition, the processor 1050 may copy a virtual image according to a received signal or may edit the virtual image such that the virtual image may be mapped to a marker, a detailed description of which will hereinafter be given with reference to the accompanying drawings.

Meanwhile, although not shown in FIG. 1, the device may include a communication unit, an audio output unit, or a power unit.

The communication unit (not shown) may communicate with an external device using various protocols to transmit/receive data to/from the external device. In addition, the communication unit may access a network in a wired or wireless fashion to transmit/receive digital data, such as augmented reality information and virtual image information. Consequently, the communication unit may transmit/receive data related to a marker to/from an external device or a web server.

The audio output unit (not shown) may include an audio output device, such as a speaker or an earphone. In addition, the audio output unit may output sound based on content executed by the processor 1050 or a control command from the processor 1050. The audio output unit may be selectively provided in the device.

The power unit (not shown) is a power source connected to a battery in the device or an external power source. The power unit may supply power to the device.

In the disclosure, the processor 1050 generates/receives an input signal, a copy trigger signal, and a copy signal. The processor 1050 may recognize the aforementioned signals simultaneously with generation of the aforementioned signals and may execute commands corresponding to the recognized signals. In addition, the aforementioned signals may be signals related to a series of events and may be regarded as commands based on user inputs. Moreover, generation/reception of a signal may be a series of data processing operations to perform an operation corresponding to an event recognized by the processor 1050 in a case in which the processor 1050 recognizes the event. In addition, sensing a predetermined user input and performing an operation corresponding thereto may entail the processor 1050 generating/receiving a signal corresponding to the predetermined user input to execute a predetermined command.

In the following description, in a case in which each step or operation performed in the device begins or proceeds in response to sensing of a user input, a process of generating and receiving a signal according to the user input is regarded as being included therein although the process of generating and receiving the signal according to the sensed user input is not repeatedly described. In addition, the processor 1050 may be represented as controlling the device or at least one unit included in the device in response to a user input and may be understood as equivalent to the device.

Meanwhile, FIG. 1 is a block diagram showing one embodiment of the device and separate blocks logically classify elements of the device. Thus, the aforementioned elements of the device may be mounted as a single chip or a plurality of chips based on device design.

FIG. 2 is a view showing a device that copies a virtual image mapped to a marker to another marker according to a received signal. More specifically, FIG. 2A is a view showing an embodiment of a device that displays a virtual image mapped to a marker. FIG. 2B is a view showing an embodiment of a device that copies a virtual image of an original marker to another marker. In the disclosure, a first marker 2030 may be an original marker to which a virtual image as a copy target is mapped. In addition, in the disclosure, a second marker 2060 may be a marker to which the virtual image of the first marker 2030 is copied and mapped.

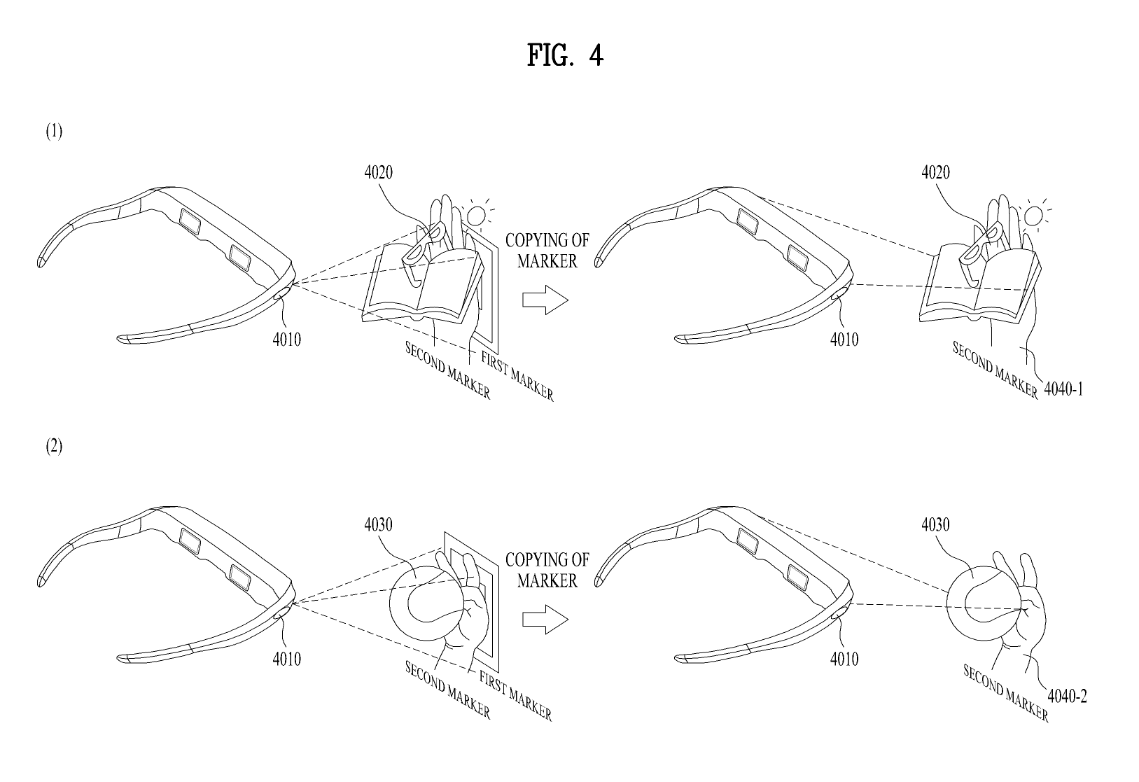

In one embodiment, as shown in FIG. 2A-(1), a device 2010 may recognize a marker using a camera unit 2020. More specifically, the device 2010 may acquire a front image using the camera unit 2020 and may recognize a marker 2030 from the acquired image. In the disclosure, the marker 2030 is not particularly restricted as long as the marker 2030 may be captured through the camera unit 2020. For example, a portion of the body of a user may be a marker. The device 2010 may recognize a portion of the body of the user and may display a virtual image corresponding thereto, a detailed description of which will hereinafter be given with reference to FIG. 4.

As shown in FIG. 2A-(2), the device 2010 may display a virtual image 2040 corresponding to the marker 2030 recognized using the camera unit 2020. More specifically, the device 2010 may receive information regarding the virtual image 2040 mapped to the recognized marker 2030 from an external server. Alternatively, the device 2010 may receive information regarding the virtual image 2040 corresponding to the recognized marker 2030 from a storage unit. In this case, the device 2010 may transmit information regarding the marker 2030 to the external server or the storage unit to request information regarding the virtual image 2040 corresponding to the recognized marker 2030.

The device 2010 may display the virtual image 2040 using the acquired information. More specifically, the device 2010 may display the virtual image 2040 mapped to the marker 2030 based on the marker 2030. The virtual image 2040 may be a stereoscopic image or a 3D image using a binocular disparity and/or a 2D image.

The device 2010 may maintain display of the virtual image 2040 while the marker 2030 is recognized through the camera unit 2020. In a case in which the marker 2030 deviates from a predetermined area, e.g. an angle of view of the camera unit 2020, or is hidden by another object, however, the device 2010 may not maintain display of the virtual image 2040. For example, in a case in which a ⅔ portion of the marker 2030 is hidden by another marker, the device 2010 may not display the virtual image 2040. On the contrary, in a case in which a predetermined portion of another marker is exposed to and thus is recognized by the camera unit 2020, the device 2010 may display a virtual image of the marker. This is because, in provision of augmented reality to a user, displaying a corresponding virtual image only during recognition of a marker is an operation which does not confuse the user and is suited to user intention. In the disclosure, however, in a case in which the device 2010 receives a copy trigger signal, the device may maintain display of the virtual image 2040 although the marker 2030 is not recognized, a detailed description of which will hereinafter be given with reference to FIG. 2B-(1).

In a case in which device 2010 receives a copy trigger signal as shown in FIG. 2B-(1), the device 2010 may maintain display of a virtual image although the first marker 2030 is not recognized. More specifically, upon receiving a copy trigger signal, the device may maintain display of the virtual image 2040 even in a case in which the first marker 2030 is hidden by another marker 2060. In the disclosure, the copy trigger signal may be a trigger signal to copy the same virtual image 2040 from one marker 2030 to another marker 2060.

In one embodiment, the copy trigger signal may be a signal generated by a predetermined selection input. More specifically, the copy trigger signal may be a signal generated by a predetermined touch and/or gesture input. For example, in a case in which the device is a device that senses a touch input to the display unit, the copy trigger signal may be a signal generated by a user touch input to a displayed soft button (not shown). At this time, the device 2010 may sense the user touch input using the sensor unit as previously described with reference to FIG. 1. On the other hand, in a case in which the device 2010 is an HMD, the copy trigger signal may be a signal generated by a user gesture input to a displayed soft button 2050. More specifically, upon detecting a user gesture of pushing the displayed soft button 2050, the device 2010 may generate a copy trigger signal. At this time, the device 2010 may sense the user gesture input using the camera unit 2020 as previously described with reference to FIG. 1.

In another embodiment, the copy trigger signal may be a generated signal based on recognition of the copy marker 2060. In the disclosure, the copy marker 2060 may be a dedicated copy marker to copy a virtual image mapped to another marker. In a case in which the copy marker 2060 is recognized, therefore, it may be expected that copying the virtual image 2040 will be performed. Consequently, the device 2010 may generate a copy trigger signal to copy the virtual image 2040. On the other hand, the copy marker 2060 also functions as a marker to display a virtual image. When the copy marker 2060 is recognized in a case in which a virtual image pre-mapped to the copy marker 2060 is present, therefore, the pre-mapped virtual image may be displayed.

When receiving the copy trigger signal, the device 2010 may maintain display of the virtual image 2040. More specifically, when the copy trigger signal is received, the device 2010 may maintain display of the virtual image 2040 although the second marker 2060 is overlaid on the first marker 2030 with the result that the first marker 2030 is not recognized. As the device 2010 maintains display of the virtual image as a copy target, a preview of the corresponding image 2040 may be provided such that a user may more easily and intuitively copy the virtual image 2040.

On the other hand, in a case in which the copy trigger signal is generated by a predetermined gesture input 2050 or a predetermined touch input, shape or kind of the second marker 2060 is not particularly restricted. That is, the second marker 2060 may copy and map the virtual image 2040 as long as the second marker 2060 is an object that may be distinguished by the camera unit 2020. In a case in which the copy trigger signal is a signal generated by recognizing the copy marker 2060, however, the marker 2060 overlaid on the first marker 2030 may be the aforementioned copy marker 2060. Various embodiments of the marker 2060 will hereinafter be described in detail with reference to FIG. 4.

In a case in which a virtual image 2040 pre-mapped to the second marker 2060 is present, the device 2010 may display the pre-mapped virtual image through recognition of the second marker 2060. When more than a predetermined portion of the second marker 2060 is overlaid on the first marker 2030, however, the device 2010 may not display a virtual image corresponding to the second marker 2060 any longer. This is because, in a case in which the copy trigger signal is received, display of the virtual image mapped to the first marker 2030 is maintained although the second marker 2060 is overlaid on the first marker 2030 with the result that two virtual images may overlap, confusing the user. When more than a predetermined portion of the second marker 2060 is overlaid on the first marker 2030, therefore, the device 2010 may not display a virtual image corresponding to the second marker 2060, thereby preventing confusion of the user. Alternatively, when the copy trigger signal is received, the device 2010 may not display a virtual image of the second marker although the second marker is recognized.

When receiving a copy signal as shown in FIG. 2B-(2), the device 2010 may map information of the virtual image 2040 of the first marker 2030 to the second marker 2060. In the disclosure, the copy signal may be a copy command to map information of the virtual image 2040 of the first marker 2030 to the second marker 2060. In the same manner as in the copy trigger signal, the copy signal may be a signal generated by a predetermined gesture input or a predetermined touch input. For example, in a case in which the device 2010 is an HMD, the copy signal may be a signal generated by a user gesture input to a displayed soft button. Upon receiving the copy signal, the device 2010 may map information regarding the virtual image 2040 to the second marker 2060 to copy the virtual image 2040 of the first marker 2030 to the second marker 2060. In a case in which the device 2010 recognizes the second marker 2060 to which copy is completed, therefore, the device 2010 may display the virtual image 2040 of the copied first marker 2030. Meanwhile, in one embodiment, in a case in which information of the virtual image 2040 has been mapped to the second marker 2060, the device 2010 may provide at least one selected from between visual and auditory feedbacks indicating completion of mapping.

The operations described with reference to FIGS. 2A-(1), 2A-(2), 2B-(1), and 2B-(2) may be performed according to the aforementioned sequences or may be freely changed within limitations allowable by those skilled in the art.

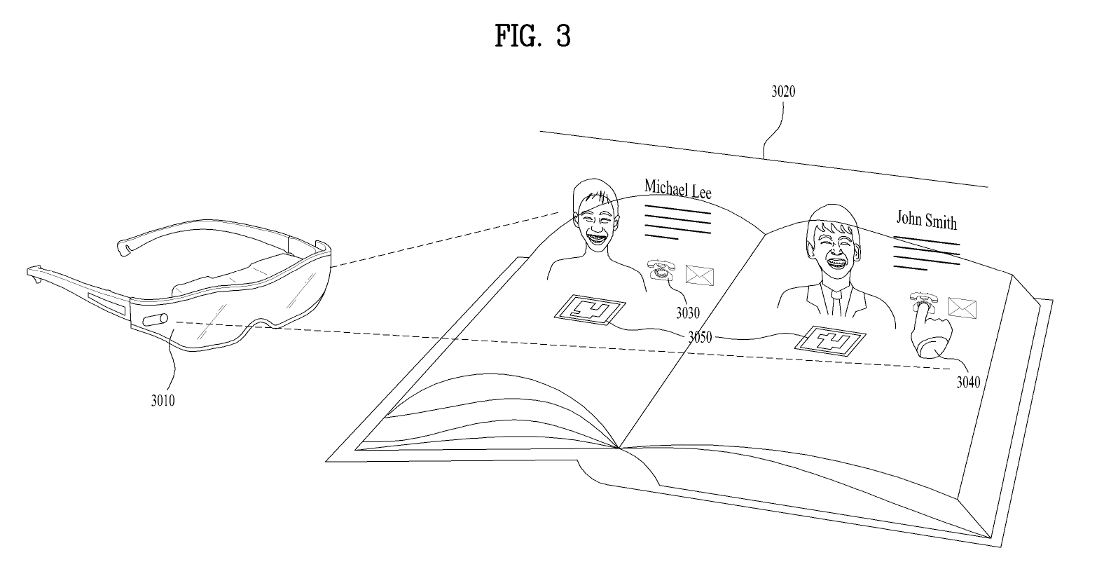

FIG. 3 is a view showing one embodiment of a virtual image scrapbook using marker copying.

As previously described with reference to FIG. 2, a user may copy a virtual image 3020 by mapping the virtual image 3020 to another marker. Consequently, user accessibility to and usability of the virtual image 3020 may be sufficiently guaranteed. In addition, the user may scrap the virtual image 3020 according to kind of the virtual image 3020, the use purpose of the virtual image 3020, and user taste.

For example, as shown in FIG. 3, the user may make a dedicated name card scrapbook. It is difficult to manage paper name cards since the sizes of the paper name cards are small. Moreover, in a case in which the number of paper name cards is increased, it is inconvenient to carry the paper name cards. Consequently, a user may simply and easily copy a virtual name card image 3020 of a name card marker to a second marker 3050, thereby overcoming the aforementioned problems. More specifically, the user may copy an original name card marker to the second marker 3050 according to the process previously described with reference to FIG. 2. The second marker 3050 is not particularly restricted as long as the second marker 3050 is an object, such as a scrapbook, a specific image pattern, and the body of the user, which may be recognized by a camera unit. Consequently, the user may copy the virtual name card image 3020 using an object that can be easily carried or accessed as the second marker 3050 as needed.

In addition, in a case in which a predetermined gesture input 3040 or a predetermined touch input to the copied virtual image 3020 is sensed, a device 3010 may execute a command corresponding to the sensed input. For example, in a case in which the virtual name card image 3020 is copied to the second marker 3050, the device 3010 may display the copied virtual name card image 3020 through recognition of the second marker 3050. At this time, the virtual name card image 3020 may be displayed together with a telephone-shaped graphical user interface (GUI) 3030 indicating contact information. Upon detecting a user gesture 3040 of pushing the displayed telephone-shaped GUI 3030, the device 3010 may execute a command for telephone connection to a subject of the virtual name card image 3020. That is, the device 3010 may also provide various user interfaces conforming to an attribute of the copied virtual image 3020 according to embodiments.

In addition, various kinds of digital content such as a movie, a drama, a novel, and music, which may be mapped to a marker, may be copied to the second marker 3050. In a case in which virtual images are copied indiscreetly, however, a copyright problem may occur. In a case in which virtual images are copied, therefore, predetermined payment may be made. Alternatively, in a case in which a virtual image copied to the second marker 3050 is displayed, the device 3010 may also display a virtual tag indicating that the virtual image 3050 is a copied image, thereby preventing occurrence of the copyright problem (not shown).

FIG. 4 is a view showing one embodiment of a device that copies a virtual image using a portion of the body of a user as a second marker.

The second marker may include various kinds of objects that may be recognized through a camera unit 4010. As previously described, embodiments of the second marker are not particularly restricted. For example, portions 4040-1 and 4040-2 of the body of the user may be recognized through the camera unit 4010 and thus may be the second marker. In this embodiment, hands 4040-1 and 4040-2 of the user may be used as the second marker.

The device may copy virtual images 4020 and 4030 using the hands 4040-1 and 4040-2 of the user as the second marker. At this time, the device may recognize the hands 4040-1 and 4040-2 of the user as different markers depending on the shape of the hands of the user. For example, upon detecting the shape of the hand 4040-1 in which the palm of the hand is directed to the camera unit in a state in which the hand is spread as shown in FIG. 4-(1) and upon detecting the shape of the hand 4040-2 in which fingers except the index finger and the middle finger are folded as shown in FIG. 4-(2), the device may recognize the hands 4040-1 and 4040-2 of the user as different markers. Consequently, the user may copy a plurality of virtual images 4020 and 4030 to one hand while changing the shape of the hand. This may be properly used by the user in a case in which the user wishes to copy a plurality of virtual images.

In addition, the device may determine whether a portion of the body recognized through the camera unit 4010 is a portion of the body of the user. In one embodiment, the device may determine whether a recognized hand is a hand of the user. More specifically, the device may detect a fingerprint or a vein of the hand of the user using the camera unit to determine whether the recognized hand is a hand of the user. Upon determining that the recognized hand is not the hand of the user, the device may not display a virtual image corresponding to the shape of the hand or may not copy the virtual image. This may be used as one embodiment in a case in which digital content requiring security is copied or displayed.

FIG. 5 is a view showing a device in a case in which an image edit signal is received through the device according to one embodiment. In the disclosure, the image edit signal may be a signal generated according to a predetermined control input to edit a virtual image as a copy target.

As previously described with reference to FIG. 2, when receiving a copy trigger signal, the device may be ready to copy a virtual image 5030-1 of a first marker 5010. More specifically, in a case in which a copy trigger signal is received and more than a predetermined portion of a second marker 5020 is overlaid on the first marker 5010, the device may be ready to copy the virtual image 5030-1. At this time, when receiving an image edit signal, the device may edit the virtual image 5030-1 to be copied according to the received image edit signal.

In this embodiment, the image edit signal may be generated by predetermined touch inputs 5040 and 5050 to the device. More specifically, the image edit signal may be generated by predetermined touch inputs 5040 and 5050 to a display unit included in the device. The predetermined touch inputs 5040 and 5050 may include various touch inputs, such as a touch input 5050 to a soft button displayed on the display unit, a gesture input 5040, multi touch inputs, a sliding touch input, a flicking touch input, a hovering input, a long-press touch input, and a short-press touch input. The image edit signal may be generated by each touch input.

The device may edit various attributes of the virtual image 5030-1 according to the image edit signal generated and received as described above. For example, the device may edit at least one selected from among color, intensity of illumination, contrast, and size of the virtual image and position and orientation of the second marker 5020 according to the image edit signal.

For example, in a case in which multi touch inputs 5040 to the display unit are sensed in a state in which the virtual image 5030-1 as a copy target is displayed and the distance between the sensed multi touch inputs 5040 is increased as shown in FIG. 5, an image extension signal may be generated. Upon receiving the image extension signal, the device may extend the displayed virtual image 5030-1 and display an extended virtual image 5030-2. At this time, upon also receiving a copy signal, the device may map the extended virtual image 5030-2 to the second marker 5020. More specifically, upon also receiving the copy signal, the device may map information regarding the extended virtual image 5030-2 to the second marker 5020.

That is, the device may edit and display the virtual image 5030-1 according to the received image edit signal and, when sensing the copy signal, may map the edited and displayed virtual image 5030-1 to the second marker 5020. The device may edit the displayed virtual image 5030-1 according to an edit signal and display an edited virtual image 5030-2 to provide a preview of the edited virtual image 5030-2.

In addition, in a case in which the device displays the edited virtual image 5030-2 through recognition of the second marker 5020, the device may also display a virtual tag indicating that the copied virtual image is the edited virtual image 5030-2 (not shown). Alternatively, in a case in which the device displays the edited virtual image 5030-2, the device may also display the original virtual image 5030-1 before the virtual image 5030-2 is edited to inform the user that the virtual image is the edited image.

On the other hand, the image edit signal may be generated by a predetermined gesture input to a virtual image as a copy target, a detailed description of which will hereinafter be given with reference to FIG. 6.

FIG. 6 is a view showing a device in a case in which an image edit signal for a virtual image is received according to one embodiment.

The image edit signal may be generated by a direct user gesture input 6040 to a virtual image 6030 although the image edit signal may be also generated by a touch input to the device as previously described with reference to FIG. 5. For example, in a case in which a user makes a gesture of moving two fingers apart with respect to the virtual image 6030, the device may detect the gesture through a camera unit and display the corresponding virtual image 6030 in an extended state. This may correspond to extended display of the image in a case in which the distance between the multi touch inputs to the display unit is increased as shown in FIG. 5. However, this embodiment is different from the embodiment of FIG. 5 in that the user may edit the image through the touch input to the display unit in the embodiment of FIG. 5 whereas the image may be edited by the direct gesture input 6040 to the virtual image 6030 in this embodiment. Consequently, this embodiment may provide a more intuitive image editing method than the embodiment of FIG. 5.

The device may edit various attributes of the displayed virtual image 6030 according to the image edit signal generated by the predetermined gesture input 6040. In addition, upon receiving a copy signal, the device may map information regarding the edited virtual image 6030 to a second marker 6020. A description of the image edit signal overlapping with or corresponding to the description previously given with reference to FIG. 5 will be omitted.

On the other hand, the user may copy the virtual image 6030 using an edit function of the virtual image 6030 in addition to the aforementioned copying method. In other words, the user may change the position of the virtual image 6030 from a first marker 6010 to the second marker 6020 according to the predetermined gesture input 6040 to edit and copy the virtual image 6030. More specifically, upon receiving a copy trigger signal, the device may be ready to copy the virtual image 6030. At this time, the device may edit attributes of the virtual image 6030 according to the received image edit signal. The user may copy the virtual image 6030 by editing the positions of the virtual image 6030 toward the markers 6010 and 6020.

For example, in a case in which the user makes a gesture 6040 of holding up the displayed virtual image using two fingers and the gesture 6040 is detected through the camera unit as shown in FIG. 6, the device may move the virtual image 6030 according to movement of the two fingers. At this time, the device may recognize a hand 6040 of the user as a temporary marker to which the virtual image is mapped and may move the virtual image 6030. In addition, in a case in which the user makes a gesture 6040 of putting the virtual image on the second marker 6020 and the gesture 6040 is detected through the camera unit, the device may map the virtual image 6030 to the second marker 6020 to copy the virtual image 6030. The user may feel as if he or she were directly controlling the virtual image 6030 through such a graphical effect.

In addition, before a copy signal is received, the device may variously edit the virtual image 6030 according to the received image edit signal. When editing of the virtual image 6030 is completed and a copy signal is received, the device may map information regarding the edited virtual image to the second marker 6020. At this time, the edited virtual image may be displayed together with a virtual tag or an original virtual image as previously described with reference to FIG. 5.

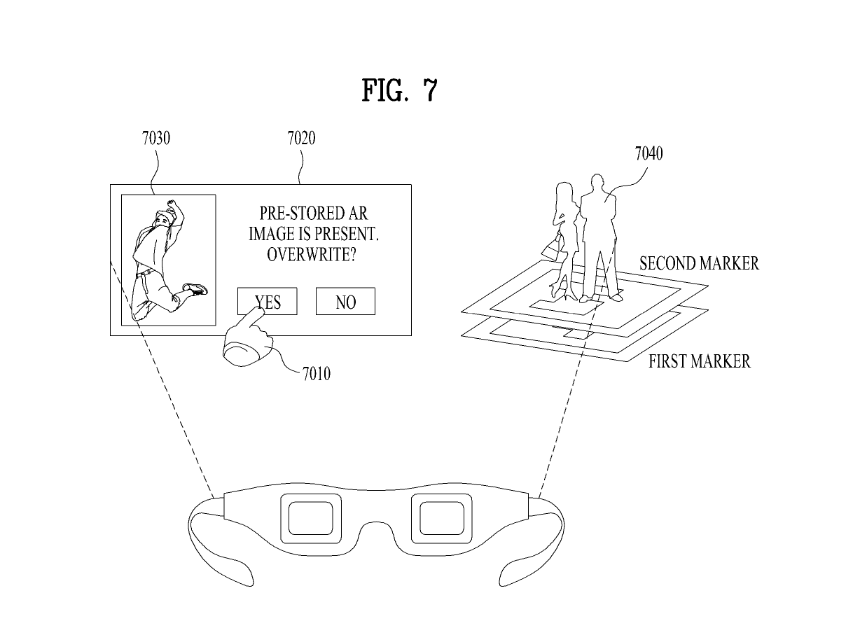

FIG. 7 is a view showing a device that provides a predetermined notification in a case in which a virtual image pre-mapped to a second marker is present according to one embodiment.

In a case in which a user wishes to copy a virtual image from a first marker to a second marker, another virtual image 7030 may be pre-mapped to the second marker. This is because shape or kind of the second marker is not particularly restricted as long as the second marker is an object that may be recognized by a camera unit as previously described. Particularly in a case in which the second marker is a copy marker, there is a strong possibility that a pre-mapped virtual image 7030 is present. In a case in which a virtual image 7040 is copied to a marker in which the pre-mapped virtual image 7030 is present, a user may be confused or the device may malfunction differently from user intention if a notification 7020 of the pre-mapped virtual image 7030 is not provided. For this reason, there is a necessity of the device providing a notification 7020 indicating that the pre-mapped virtual image 7030 is present.

In a case in which the pre-mapped virtual image 7030 is present in the second marker, the device may provide a notification 7020 indicating that the pre-mapped virtual image 7030 is present when a copy signal is received. At this time, the provided notification 7020 may include at least one selected from among a visual notification, an auditory notification, a tactile notification, and an olfactory notification. In a case in which the device provides a visual notification 7020, the device may provide a visual notification 7020 of “A pre-stored AR image is present. Overwrite?” may be provided as shown in FIG. 7.

In addition, the device may overwrite the virtual image 7040 according to a selection input 7010 corresponding to the provided notification 7020 or may also map the virtual image 7040 to the second marker additionally. More specifically, the device may replace the previously mapped virtual image 7030 with a copy object image 7040 and may map the copy object image 7040 to the second marker according to the detected selection input. At this time, an input signal may be generated by the detected selection input. For example, in a case in which a visual notification 7020 is present as shown in FIG. 7, the user may input a gesture 7010 to select a selection window of “YES” to replace the pre-mapped virtual image 7030 with a virtual image 7040 to be copied. More specifically, information regarding the pre-mapped virtual image 7030 may be replaced with information regarding an object image 7040 to be copied. In this case, the information regarding the pre-mapped virtual image 7030 may be deleted.

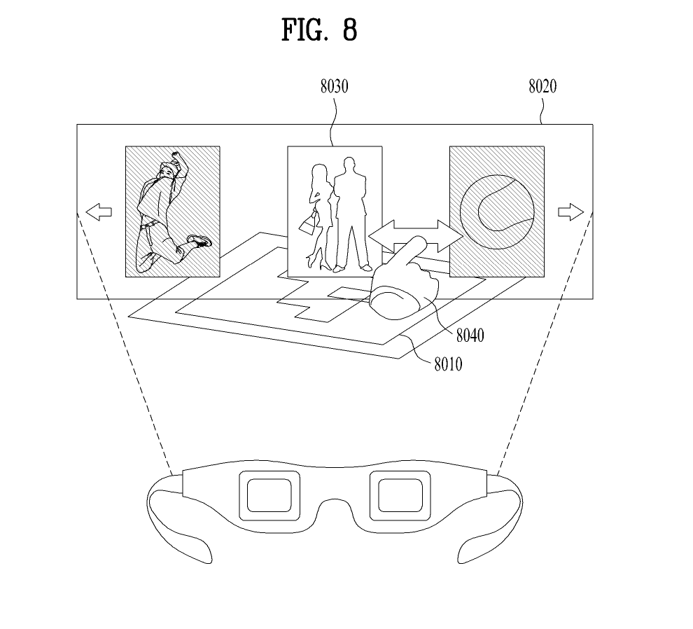

In addition, the device may add a virtual image 7040 to be copied to the second marker pre-mapping virtual image 7030 according to the detected selection input (not shown). More specifically, the device may map the information regarding the pre-mapped virtual image 7030 and information regarding the copy object image 7040 to the second marker. As a result, a plurality of virtual images 7030 and 7040 may be mapped to the second marker. At this time, when the second marker is recognized, the device may provide thumbnails for the virtual images 7030 and 7040, a detailed description of which will hereinafter be given with reference to FIG. 8.

Meanwhile, provision of the notification 7020 may be set by the user according to design or purpose of the device or kind of application that is being executed. According to setting, the copy object image 7040 may be directly replaced or added and then mapped upon receiving a copy signal without provision of the notification 7020.

FIG. 8 is a view showing a device that provides thumbnails to respectively select virtual image to be displayed in a case in which the virtual images are mapped to one marker according to one embodiment.

As previously described with reference to FIG. 7, a plurality of virtual images may be mapped to a second marker 8010. In a case in which the second marker 8010, to which the virtual images are mapped as described above, is recognized through a camera unit, the device may have a trouble in displaying one of the virtual images. In this case, therefore, the device may display thumbnails 8020 for the virtual images to provide a user with an interface to select one of the virtual images.

The user may navigate through the displayed thumbnails 8020 through sliding on the displayed thumbnails 8020 or a flicking gesture input 8040 to the displayed thumbnails 8020. At this time, the device may provide various graphical effects, such as a page turning effect, a page scrolling effect, and a page rotation effect, corresponding to the user gesture input 8040. Subsequently, the user may select a thumbnail 8030 for one of the virtual images which the user wishes to display to select the virtual image which the user wishes to display on the basis of the marker 8010. Upon sensing a selection input to a specific thumbnail 8030, the device may display a virtual image corresponding to the specific thumbnail 8030 on the basis of the marker. More specifically, the device may retrieve information regarding the virtual image corresponding to the selected thumbnail 8030 and may display the corresponding virtual image on the basis of the marker 8010.

FIG. 9 is a flowchart showing a control method of a device that copies a virtual image from a first marker to a second marker. In the flowchart, a detailed description of parts similar to or corresponding to the above description of FIGS. 1 to 8 will be omitted.

First, the device may capture an image of the surroundings of the device (S9010). More specifically, the device may acquire an image of the surroundings of the device using a camera unit.

The device may recognize a first marker from the acquired surrounding image (S9020). The first marker may be an original marker mapping a virtual image to be copied.

The device may acquire information regarding the virtual image mapped to the recognized first marker, i.e. a first virtual image (S9030). The device may receive information regarding the first virtual image from an external server or a web server or may receive information regarding the first virtual image stored in a storage unit to acquire the information regarding the first virtual image, a detailed description of which has been previously given with reference to FIG. 1.

The device may display the first virtual image using the acquired information regarding the first virtual image (S9040). A detailed description of displaying the first virtual image has been previously given with reference to FIG. 2A.

Subsequently, the device may determine whether a copy trigger signal is received (S9050). The copy trigger signal may be a trigger signal to copy the first virtual image from the first marker to a second marker. Alternatively, the copy trigger signal may be a trigger signal to prepare for copying before copying of the first virtual image is performed. The copy trigger signal may be generated by a predetermined user input or recognition of a copy marker through the camera unit, a detailed description of which has been previously given with reference to FIG. 2B.

When receiving the copy trigger signal, the device may maintain display of the first virtual image although the second marker is overlaid on the first marker with the result that the first marker is not recognized any longer (S9060). The second marker may be a marker to which the first virtual image is copied and mapped. More specifically, upon receiving the copy trigger signal, the device may be ready to copy the first virtual image. At this time, in a case in which more than a predetermined portion of the second marker is overlaid on the first marker, the device may maintain display of the first virtual image. In addition, upon receiving an image edit signal in a state in which the device is ready to copy the first virtual image, the device may edit the first virtual image according to the received signal, a detailed description of which has been previously given with reference to FIGS. 5 and 6.

On the other hand, upon not receiving the copy trigger signal, the device may return to the step (S9040) of displaying the first virtual image.

Subsequently, the device may determine whether a copy signal is received (S9070). The copy signal may be a copy command signal to map virtual image information of the first marker to the second marker. In the same manner as the copy trigger signal, the copy signal may be a signal generated by a predetermined user input, a detailed description of which has been previously given with reference to FIG. 2B.

Upon receiving the copy signal, the device may map the information regarding the first virtual image to the second marker (S9080). The second marker may be a marker to which the virtual image of the first marker is copied and mapped. When the information regarding the first virtual image is mapped to the second marker, copying of the first virtual image is completed. At this time, the device may provide a visual or auditory feedback indicating that copying of the first virtual image is completed, a detailed description of which has been previously given with reference to FIG. 2B.

Upon not receiving the copy signal, the device may return to the step (S9060) of maintaining display of the first virtual image in a state in which the second marker is overlaid on the first marker.

Meanwhile, although not shown in the flowchart, a plurality of virtual images may be mapped to the second marker through the aforementioned process as previously described with reference to FIG. 8. In addition, in a case in which the device recognizes a marker to which a plurality of virtual images is mapped, the device may provide a plurality of thumbnails for the virtual images and a user may select one of the virtual images which the user wishes to display through the thumbnails as previously described with reference to FIG. 8.

As is apparent from the above description, according to one embodiment, a virtual image may be copied and mapped to another marker. Consequently, it is possible to improve user accessibility to and usability of the virtual image.

According to another embodiment, upon receiving a copy trigger signal, display of a virtual image may be maintained although another marker is overlaid on an original marker. Consequently, it is possible to provide a preview of the virtual image to be copied.

According to a further embodiment, a mode to edit a virtual image before copying the virtual image may be provided. Consequently, it is possible for a user to freely edit and map the virtual image.

Although the respective drawings have been described for convenience of description, the embodiments described with reference to the respective drawings may be combined with one another to realize novel embodiments. In addition, a computer readable recording medium in which a program to execute the above-described embodiments is stored may be designed as needed within the scope of the disclosure.

In addition, the device and the control method thereof are not limited to the configuration and method of the above-described embodiments, and some or all of the above-described embodiments may be selectively combined with one another to enable various modifications.

It will be apparent that, although the preferred embodiments have been shown and described above, the disclosure is not limited to the above-described specific embodiments, and various modifications and variations can be made by those skilled in the art without departing from the gist of the appended claims. Thus, it is intended that the modifications and variations should not be understood independently of the technical spirit or prospect of the disclosure.

In the disclosure, it will be understood that angles, distances, and lengths may represent accurate values and, in addition, may also represent substantial angles, distances, and lengths within a predetermined range. That is, the angles, distances, and lengths of the disclosure may represent substantial angles, distances, and lengths within a tolerance range.

In addition, the disclosure describes both a device invention as well as a method invention, and descriptions of both inventions may be complementarily applied as needed.

What is claimed is:

1. A display device comprising:
a sensor unit configured to sense an input to the display device;
a camera unit configured to capture a surrounding image of the display device;
a display unit configured to display a virtual image; and
a processor configured to control the sensor unit, the camera unit, and the display unit,
wherein the processor is further configured to:
acquire information regarding a first virtual image mapped to a first marker and display the first virtual image using the acquired information regarding the first virtual image, when the first marker is recognized from the captured surrounding image,
maintain display of the first virtual image, when a copy trigger signal for the first virtual image is received and a second marker is overlaid on the first marker, and
map the information regarding the first virtual image to the second marker, when a copy signal for the first virtual image is received.

2. The display device according to claim 1, wherein the copy trigger signal is generated by a predetermined gesture input or a predetermined touch input.

3. The display device according to claim 2, wherein the predetermined gesture input or the predetermined touch input is a selection input to a virtual button displayed on the display unit.

4. The display device according to claim 1, wherein, when the second marker is a copy marker, the copy trigger signal is generated by recognizing the second marker from the captured surrounding image.

5. The display device according to claim 1, wherein the display unit comprises an optical see-through display panel.

6. The display device according to claim 1, wherein, when the information regarding the first virtual image is mapped to the second marker, the processor is further configured to:
acquire the information regarding the first virtual image mapped to the second marker and display the first virtual image using the acquired information regarding the first virtual image, when the second marker is recognized from the captured surrounding image.

7. The display device according to claim 6, wherein, when the first virtual image is displayed according to the information regarding the first virtual image mapped to the second marker,
the processor is further configured to display the first virtual image together with a virtual tag indicating that the first virtual image is a copied virtual image.

8. The display device according to claim 1, wherein the processor is further configured to:
edit and display the first virtual image according to an image edit signal when the display of the first virtual image is maintained and the image edit signal is received, and
map information regarding the edited first virtual image to the second marker when the copy signal is received.

9. The display device according to claim 8, wherein the image edit signal is generated by a control input to the displayed first virtual image.

10. The display device according to claim 8, wherein the processor is further configured to edit an attribute of the first virtual image according to the image edit signal.

11. The display device according to claim 10, wherein the attribute of the first virtual image comprises at least one among color, intensity of illumination, contrast, size, position and orientation of the first virtual image.

12. The display device according to claim 1, wherein, when information regarding a second virtual image is pre-mapped to the second marker, the processor is further configured to provide a notification indicating that the information regarding the second virtual image is pre-mapped to the second marker when the copy signal is received.

13. The display device according to claim 12, wherein, when an input signal corresponding to the notification is received, the processor is further configured to replace the information regarding the second virtual image with the information regarding the first virtual image or add the information regarding the first virtual image to the information regarding the second virtual image according to the received input signal.

14. The display device according to claim 1, wherein, when information regarding a plurality of virtual images is mapped to the first marker, the processor is further configured to display a thumbnail for at least one of the virtual images when the first marker is recognized from the captured surrounding image.

15. The display device according to claim 14, wherein, when one of the virtual images is selected through the thumbnail, the processor is further configured to display the selected virtual image on a basis of the first marker.

16. The display device according to claim 1, wherein, when mapping of the information regarding the first virtual image to the second marker is completed, the processor is further configured to provide at least one of visual and auditory feedbacks indicating the completion of mapping.

17. The display device according to claim 1, further comprising:
a storage unit configured to store information regarding the virtual image, wherein the processor is further configured to control the storage unit to store the information regarding the virtual image.

18. A control method of a display device comprising:
capturing a surrounding image of the display device using a camera unit;
recognizing a first marker from the captured surrounding image;
acquiring information regarding a first virtual image mapped to the recognized first marker and displaying the first virtual image using the acquired information regarding the first virtual image;
maintaining display of the first virtual image when a copy trigger signal for the first virtual image is received and a second marker is overlaid on the first marker; and
mapping the information regarding the first virtual image to the second marker when a copy signal for the first virtual image is received.

19. The control method according to claim 18, wherein the copy trigger signal is generated by a predetermined gesture input or a predetermined touch input.

20. The control method according to claim 18, wherein, when the second marker is a copy marker, the copy trigger signal is generated by recognizing the second marker from the captured surrounding image.
